(19) United States
(12) Patent Application Publication
(10) Pub. No.: US 2005/0207342 A1
(43) Pub. Date: Sep. 22, 2005

(54) Communication terminal device, communication terminal receiving method, communication system and gateway

(76) Inventors: Shiro Tanabe, Hidaka (JP); Hiroki Ikeda, Beijing (CN); Yuanchen Ma, Beijing (CN); Zhisheng Niu, Beijing (CN); Jing Liu, Beijing (CN); Wen Du, Beijing (CN)

Correspondence Address: REED SMITH LLP, Suite 1400, 3110 Fairview Park Drive, Falls Church, VA, 22042, US

(21) Appl. No.: 11/059,322

(22) Filed: Feb. 17, 2005

(30) Foreign Application Priority Data
Mar. 19, 2004 (CN) 200410030175.3

(51) Int. Cl. H04L 12/28; H04L 12/56

(52) U.S. Cl. 370/235; 370/352; 370/412

(57) ABSTRACT

This invention provides a communication terminal device, a communication terminal receiving method, a communication system with the terminal device and a gateway which stabilize the time delay during VoIP communication and improve the voice quality. The invention comprises: a data packet unpacking unit; a receiving buffer; a decoding unit; a playing unit; and a central control unit. The central control unit comprises: a network state decision section for deciding whether the network is in a spike state according to the received data packets; a buffer adjusting section which predicts the subsequent data packets in one group of data packets when the network is decided to be in a normal state to adjusts the size of the buffer and predicts the subsequent data packets in one data packet when the network is decided to be in a spike state to enlarges the buffer.

### TECHNICAL FIELD OF THE INVENTION

The present invention relates to communication terminal device, communication terminal receiving method, communication system with the communication terminal device and gateway, more specifically, relates to the technology of voice quality improvements in IP telephone communication.

### BACKGROUND OF THE INVENTION

Internet has gradually become an important means of communication after a period of rapid development due to its large coverage area and cheapness, therefore, it has become an important development direction for telephone to transmit voice data on internet and support IP telephone. The basic principle of implementing VoIP is as follows: the voice is packed into data packets after being encoded, then the data packet are transferred to the terminal through internet by means of transmitting in a maximum capability according to UDP protocol, and the voice data is played after removing the IP header according to the sequence of the data packets and decoding by the terminal.

Since the voice data packets of IP telephone are transferred by means of transmitting in a maximum capability according to UDP protocol, it will definitely have certain effect on the voice service. First, the sequential data packets in the same connection are sent from the sending end at a fixed time interval. If the network load is the same and they pass the same route of the network, they will experience the same time delay, and will arrive at the receiving end at the fixed time interval, however, the internet is characterized by transmitting in a maximum capability and sending in jump without fixed route, therefore, different data packets in the same connection may pass different routes, and even they pass the same route, the time delay of queue for the sequential packets will be different since the spike state of the network at different time will not be the same. As a result, the data packets will arrive at the terminal at a different time interval with the fixed time interval, and thereby causing a difference between the preset arrival time and actual arrival time of each packet, i.e., resulting in a time delay fluctuation which may cause disorder and lose of voice data packets in the most serious circumstance.

FIG. 1 shows the principle of generating time delay fluctuation, where Pi represents data packet i.

Since telephone is a real-time service, a long time delay is unacceptable for clients. At the same time, the time delay fluctuation of sequential two packets will make the voice quality worse, that is to say, the later voice will overlay the earlier one when the interval becomes shorter or blank will occur in the voice continuance when the interval becomes longer, and the continuous long intervals will bring about change of voice tone.

It is impossible to avoid the time delay becoming longer and time delay fluctuation because of the characteristic of transmitting in a maximum capability. Consequently, the most important problem in VoIP communication is to control time delay and time delay fluctuation so as not to make the voice quality worse.

FIG. 2 shows the constitution of end-to-end delay in a network, where Dₚᵣₒₚ and Dₜᵣₐₙₛ, determined by the network, represent propagation time delay and transmission time delay respectively, D_{proc} is the machine processing time delay required for playing voice packets, D_{play} is the time required for playing voice packets, and dᵢ is the time delay between sending the voice packets from a sending end and playing the voice packets at a receiving end. In order to keep the value of dᵢ as a constant so as to reduce the time delay fluctuation, D_{queuing}, the queuing delay in buffer, should be adjusted.

Based on the different values of time delay and time delay fluctuation, there exist two states for internet: normal state and spike state. FIG. 3 illustrates the difference between the two states. In a normal state, the time delay values of adjacent data packets in the network are generally different (because of the non-conjunction characteristic of the internet), however, the difference, i.e., the time delay fluctuation is not obvious. In addition, the size of receiving end buffer is kept within a certain range with no a big change, therefore it is impossible that the data packet is depleted. In a spike state, the state can be divided into two portions: the first half and the second half. In the first half portion of the state, data packets will arrive late in this period of time and the data packets in buffer are in danger of depletion because the most data packets are blocked the network. The buffer depletion means that the buffer cannot be used for compensating the fluctuation of data packet arrival time. In the second half portion of the spike burst state, the number of data packets in the buffer will be suddenly increased and the time delay of packets will be increased to an insufferable state because the most data packets blocked the network will arrive at the same time.

### SUMMARY OF THE INVENTION

The present invention provides a communication terminal device, a communication terminal receiving method, a communication system with the terminal device and a gateway that stabilize the time delay during VoIP communication and improve the voice quality.

The communication terminal device of this invention for use in IP telephone communication comprises: a data packet unpacking unit for unpacking the received data packets containing the voice information; a receiving buffer for storing the unpacked data packets; a decoding unit for decoding the data packets saved in the receiving buffer; a playing unit for playing the voice information after the decoding unit decodes it; and a central control unit for controlling the data packet unpacking unit, the receiving buffer and the playing unit, wherein the central control unit comprises:

a network state decision section for deciding whether the network is in a spike state according to the received data packets; and

a buffer adjusting section, which predicts the sequent data packets in one group of data packet when the network is decided to be in a normal state to adjust the size of buffer, and predicts the sequent data packets in one data packet when the network is decided to be in a spike state to enlarge the buffer.

The decision of network state means that the network is decided to be in a spike state when the time delay of data packets received by the data packet unpacking unit is larger than the preset first lower limit value of the delayed time of data packets.

The decision of network state means that the network is decided to be in a spike state when the time interval of data packets received by the data packet unpacking unit is larger than the preset first lower limit value of the time delay of data packets.

The decision of network state means that the network is decided to be in a normal state when the number of data packets stored in the receiving buffer is less than the preset first lower limit value, and the network is decided to be in a normal state when the number of data packets stored in the receiving buffer is larger than the second lower limit value which is higher than the first lower limit value.

The buffer enlarging means that the central control unit inserts dummy packets to the receiving buffer from the head of the queue when the network state decision section decides that the network is in a spike state.

The buffer enlarging means that the central control unit inserts dummy packets at the position of VAD packet in the buffer when the network state decision section decides that the network is in a spike state.

The one group of data packet unit means a talk spurt.

The sequent data packets are predicted with NLMS algorithm when the network is decided to be in a spike state.

VAD data packet in the buffer is deleted when the number of data packets in the buffer is larger than the preset upper limit value.

A method of receiving IP telephone data according to the present invention comprises the steps of:

deciding whether the network is in a spike state according to the received data packets; and

predicting the sequent data packets in one group of data packet when the network is decided to be in a normal state to adjust the size of the buffer, and predicting the sequent data packets in one data packet when the network is decided to be in a spike state to enlarge the buffer.

The present invention provides a gateway connected between a router and a telephone for use in IP telephone communication which comprises:

a data packet unpacking unit for unpacking the received data packets containing the voice information; a receiving buffer for storing the unpacked data packets; a decoding unit for decoding the data packets saved in the receiving buffer; a playing unit for playing the voice information after the decoding unit decodes it; and a central control unit for controlling the data packet unpacking unit, the receiving buffer and the playing unit, wherein the central control unit comprises:

a network state decision section for deciding whether the network is in a spike state according to the received data packets; and

a buffer adjusting section, which predicts the sequent data packets in one group of data packet when the network is decided to be in a normal state to adjust size of the buffer, and predicts the sequent data packets in one data packet when the network is decided to be in a spike state to enlarge the buffer.

The present invention provides a gateway connected between a router and a telephone for use in IP telephone communication which comprises:

a sending device, a receiving device and a router which connects the sending device with the receiving device via internet, the receiving device comprises:

a data packet unpacking unit for unpacking the received packets containing the voice information; a receiving buffer for storing the unpacked data packets; a decoding unit for decoding the data packets saved in the receiving buffer; a playing unit for playing the voice information after the decoding unit decodes it; and a central control unit for controlling the data packet unpacking unit, the receiving buffer and the playing unit, wherein the central control unit comprises:

a network state decision section for deciding whether the network is in a spike state according to the received data packets; and

a buffer adjusting section, which predicts the sequent data packets in one group of data packet when the network is decided to be in a normal state to adjust the size of buffer, and predicts the sequent data packets in one data packet when the network is decided to be in a spike state to enlarge the buffer.

### BRIEF DESCRIPTION OF THE DRAWINGS

FIG. 1 shows the principle of generating time delay fluctuations;

FIG. 2 shows the structure of time delay in the network;

FIG. 3 shows two different states of the network;

FIG. 4 shows the propagation principle of IP telephone;

FIG. 5 shows a block diagram of the communication terminal device according to the present invention;

FIG. 6 shows a schematic diagram of time stamp in RTP packet;

FIG. 7 shows a module diagram of NLMS algorithm;

FIG. 8 shows a simple self-adaptive algorithm of buffer size;

FIG. 9 shows a schematic diagram of circular queue and dummy packet inserting;

FIG. 10 shows subsection time domain characteristic of voice; and

FIG. 11 shows a flow chart of a buffer control performed by a control module.

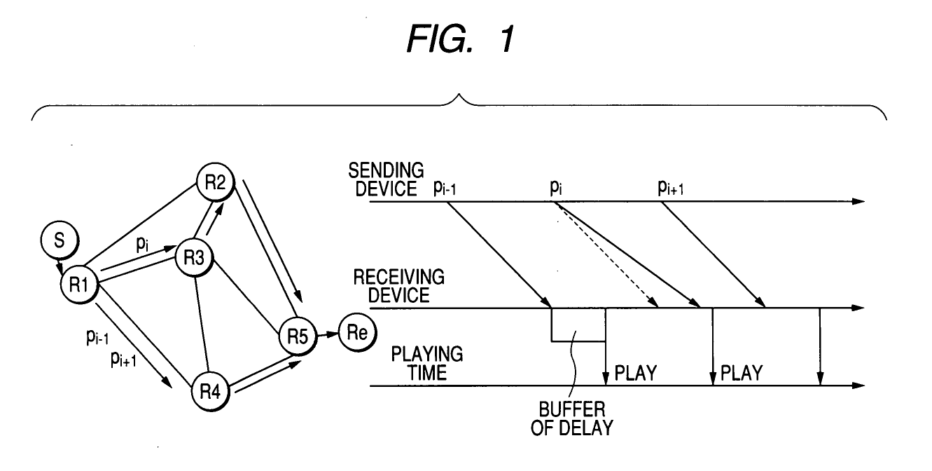

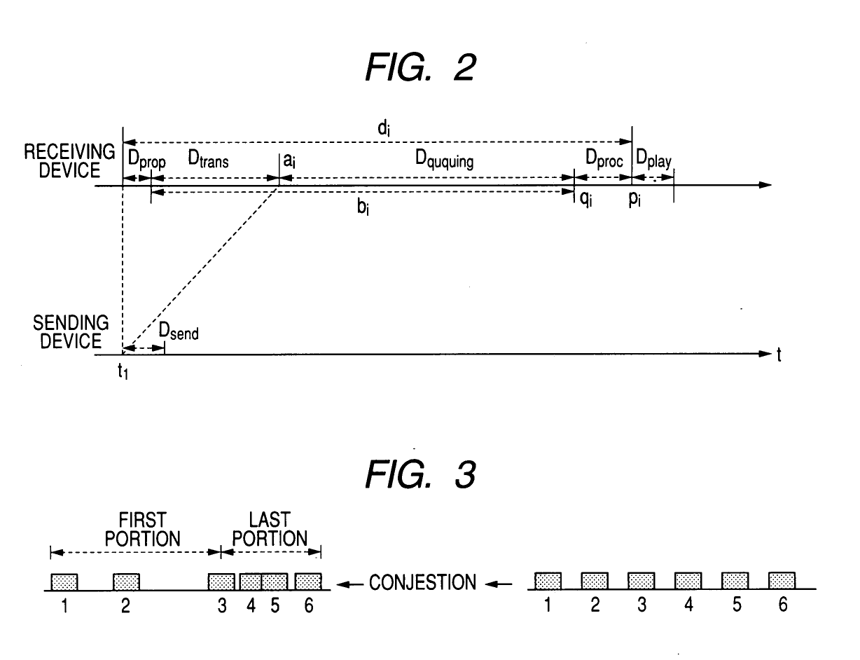

### DESCRIPTION OF THE PREFERRED EMBODIMENTS

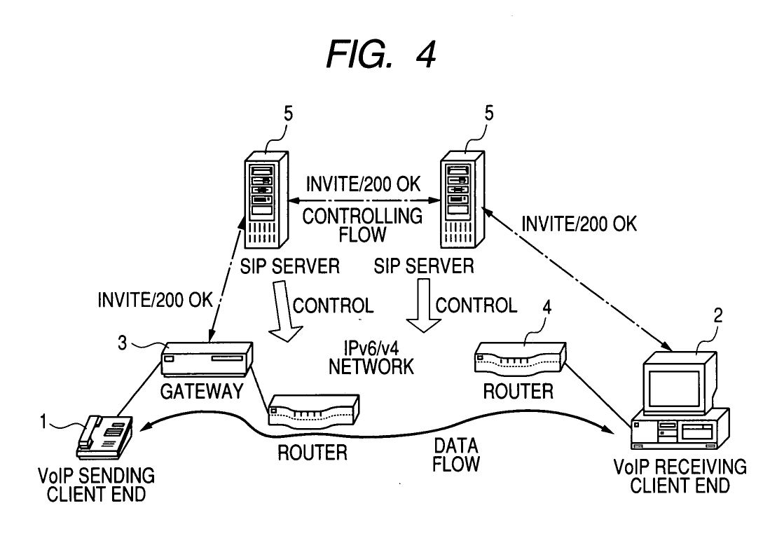

FIG. 4 shows a propagation principle of ordinary IP telephone.

As shown in FIG. 4, the communication terminal system according to the present invention consists of VoIP sending client end 1, VoIP receiving client end 2, gateway 3, router 4, SIP server 5 and the core internet, wherein the VoIP client end, i.e., the communication terminal device, may be a special VoIP device, (such as a computer installed with VoIP software or a special VoIP telephone), or an ordinary telephone with a gateway. It is shown in FIG. 4 that the sending client end consists of an ordinary telephone and a gateway, while the receiving client end consists of a computer installed with VoIP software, however, this is merely an illustration of the terminal device and not limitation thereof, and so any structure of the above-mentioned form will be available.

The sending client end first finds out the receiving client end through the SIP server 5 by using SIP control signaling, then calls it and set up a connection with it. After setting up the connection, the two communication ends transfer data flows through router 4 and the core network.

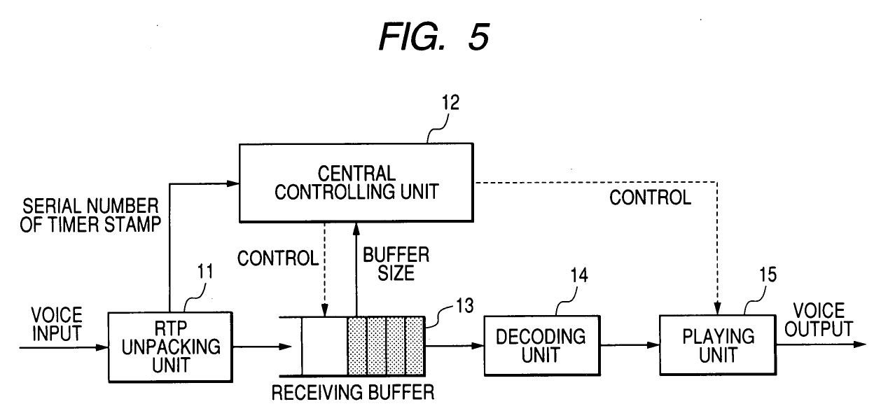

FIG. 5 shows a block diagram of the communication terminal device according to the present invention. As shown in FIG. 5, the communication terminal devices comprise: a RTP data packet unpacking unit 11 for unpacking received packets containing voice information; a receiving buffer 13 for storing unpacked data packets; a decoding unit 14 for decoding the data packets stored in the receiving buffer; a playing unit 15 for playing the voice information decoded by the decoding unit; and a central control unit 12 for controlling the RTP data packet unpacking unit, the receiving buffer and the sending unit.

Here, concerning the communication terminal device, the sending client end performs voice collecting, decoding, packing and sending, while the receiving client end performs voice packet receiving, unpacking, fluctuation adjusting, decoding and playing.

If the sending client end is a special VoIP device, voice collecting, decoding, packing and sending will be totally carried out by the device. If the sending client end consists of an ordinary telephone and a gateway, the telephone will perform the voice collecting and 64 kbpsPCM encoding, then, the gateway will accomplish the further compressing, encoding and packing.

Therefore, if the receiving client end is a special VoIP device, the block diagram of function module will be the same as FIG. 5, and if the receiving client end consists of a gateway and an ordinary telephone, it will be the same as FIG. 5 except the playing unit shown in FIG. 5 is not included in the gateway.

The RTP data packet unpacking unit collects the time stamp in RTP (real-time transmission protocol) data packets and draws out information there from. The head of each RTP packet at the receiving end contains a time stamp that represents the local absolute time when the sending end sends the data packet. However, it is generally impossible for the receiving end and the sending end to be synchronized, so the time delay value obtained by comparing the local time of the receiving end and the sending end is not accurate. Therefore, the time delay parameter should be obtained from the value of time delay fluctuation which is obtained by comparing the difference between the time stamps of two consecutive data packets and the difference of the time the two packets arrive at the receiving end, and the time delay value is evaluated relatively according to the value of time delay fluctuation of the sending end and the average size of the buffer.

The control module first sets a timer so as to pick up data packets from the buffer and play them at regular intervals, and triggers the self-adaptive adjustment of buffer by using the timer that sends one voice packet each time.

In order to stabilize the time delay during VoIP communication, it is necessary to detect the state of network first. The network state can be determined by the following two methods:

The first method decides the beginning of spike state by determining the lost packets. Once two packets are lost consecutively, that is to say, when the two packets are about to be played, they still haven't arrived, then the network is decided to be in a spike state. After the network has entered a spike state, the prediction of arrival time delay of data packets will be activated, and the network will be considered to be out of a spike state when the prediction algorithm detects that the network has turned into a normal state.

More specifically, it is possible to detect whether the network is in a spike state by the following ways, for instance, the network is considered to be in a spike state when the time delay of the data packets received by the data packet unpacking unit is larger than the preset threshold value of the time delay of data packets.

Or, the network is decided to be in a spike state when the time interval of the data packets received by the data packet unpacking unit is larger than the preset threshold value of the time interval of data packets.

In the second method, two thresholds, namely the upper threshold L_{high} and the lower threshold L_{low},ar, are set for the size of the buffer (i.e., the number of data packets in the buffer) by monitoring the buffer size, and the network is considered to be in a spike state when the size of the buffer is smaller than L_{low}, then the network is considered to have returned to a normal state only when the size of the buffer is larger than L_{high}.

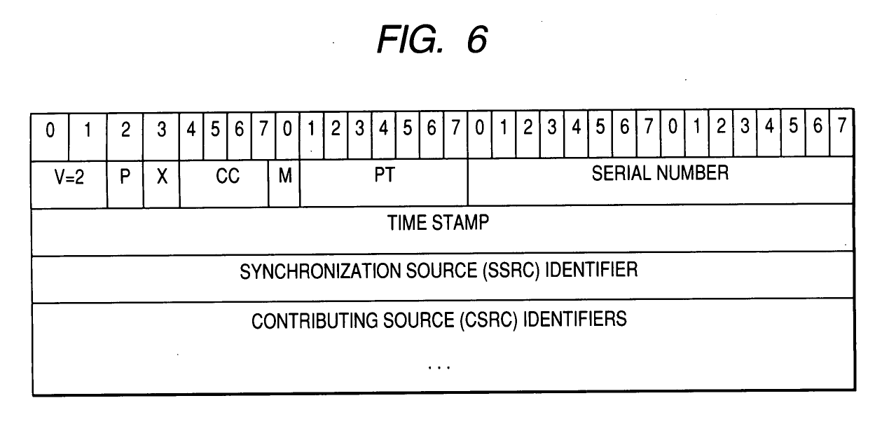

When the network is detected to be in a normal state, the receiving end collects time stamp information in the head of each RTP packet, and calculates the relative arrival time delay value of the data packets, and then decides the network state according to the time delay of data packets and the situation of packet loss. This method will put a certain computation load on the receiving end. FIG. 6 shows a schematic diagram of time stamp in a RTP packet. Since this method is a well-known technology, detailed description is excluded here. In addition, the network state also can be detected by monitoring size of the buffer, and this is a preferable way to monitor the state of network because there are no heavy task and additional computation to be performed at the receiving end in this case.

After collecting the information of network state, it is necessary to adjust the buffer, namely to adjust the average queue length in the buffer, i.e., the number of data packets. In a normal state, the adjustment of buffer is carried out in one group of data packets in order not to increase computation load on the communication terminal. For example, the buffer is adjusted according to voice gaps, that is, every time when a silent period ends, buffer size of the next talk spurt is set according to the time delay during the previous talk spurt or the statistical parameter of the buffer length.

If E(vᵢ)represents an average value of time delay of the data packets in the previous talk spurt, D(vᵢ)^{1/2} represents a variance of time delay of the data packets in the previous talk spurt, and 4 is a safety factor that assures the time delay of a certain percentage of the data packets will not exceed the above values, then the bᵢ, that should be set in the next talk spurt, can be calculated by the following equation:
bᵢ=E(vᵢ)+4\sqrt{D(vᵢ)}.

When the network is in a spike state, the following processing will be followed at the receiving end.

Once the network detecting module detects that the network is in a spike state, the receiving end will soon collect the time stamp information in the head of each RTP packet in one data packet, instead of in one group of data packets in a normal state, and calculate the arrival time delay fluctuation and relative time delay value of the data packets in order to adjust the data packets in the buffer according to the received data packets as soon as possible.

After getting these time delay parameters, there may be several processing methods as follows:

1. Adopting NLMS Algorithm to Predict Time Delay:

NLMS (Normalized Least Mean Square, an estimation algorithm) has been proved to be a better prediction algorithm. With the use of appropriate parameters, it can be convergent in a random process that has no violent variations According to the system in the present invention, the receiving end adopts NLMS to predict the possible time delay of later data packets based on the time delay parameters of the previous packets when the network is in a spike burst state.

The improved discrete NLMS algorithm is used to adjust the buffer parameters after the prediction.

NLMS itself is an estimation algorithm which takes continuous values, however, in an actual system, it is difficult to adjust the playing time of the system, while easy to add or delete data packets in the buffer. Therefore, in the present invention, the playing time of the data packets are adjusted by inserting dummy voice packets when the network is in a spike state, and reduce the buffer by deleting dummy voice frame when the buffer is too large.

As a result, the predicted value must be a discrete value that is integer times greater than the playing time of the data packets. After predicting continuous time delay values with NLMS, it is necessary to discretize the continuous values so as to control the receiving buffer using the discrete values.

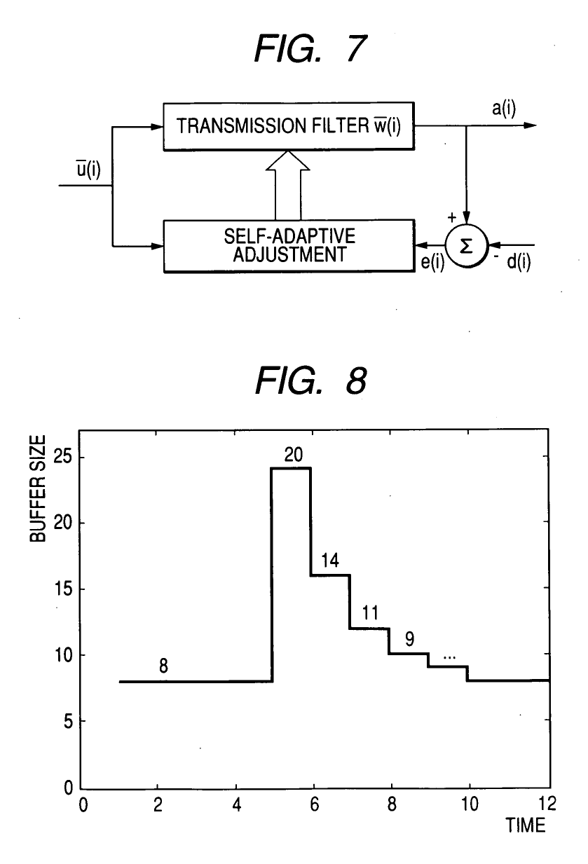

FIG. 7 shows a module diagram of NLMS algorithm, where \overline{u}(i), the time delay data of VoIP data packet obtained before the current time, is the input; \hat{d}(i), the predicted value of time delay of the current data packet obtained based on the previous time delay data, is the output; d(i) is the actual time delay value of current data packet, and e(i) is the difference between the predicted value and the actual value. The computing method in the above figure can be expressed by the following formula:

$$\begin{matrix}{\hat{d}}_{i} = {\overline{w}}_{i}^{T} {\overline{u}}_{i} \\ {e}_{i} = {d}_{i} - {\hat{d}}_{i} \\ {\overline{w}}_{i + 1} = {\overline{w}}_{i} + \frac{μ}{{\overline{u}}_{i}^{T} {\overline{u}}_{i} + a} {\overline{u}}_{i} {e}_{i} .\end{matrix}$$

In the formula, \overline{w}(i) is the filter factor, μ determines the speed of modifying the factor with the difference, and the “a” assures the denominator will not be too small.

2. Simple Self-Adaptive Algorithm Similar to TCP Flow Control:

This is a simplified prediction control algorithm for use in the case of requiring a smaller time delay. Since a smaller time delay means that the buffer cannot store too much data packets in it, and so a complicated scheduling algorithm is meaningless to such a condition, but some simplified algorithms can be applied to. Here, an algorithm similar to the retransmission window size control during the flow control in TCP protocol is proposed as follows:

Once the system detects that the network is in a spike state, it will immediately enlarge the buffer to enable the time delay of data packets to become a maximum time delay value (discrete value) that is acceptable for this service, and then continuously detect the spike state of network by means of the time stamp in head of each RTP data packet and the actual arrival time. Once the system finds the network turned into a normal state, it will reduce the enlarged buffer to a half of the original size so as to reduce the size of buffer until it returns to the size of normal state. FIG. 8 shows such a simple self-adaptive algorithm of the buffer size.

Method of Adjusting Buffer Size:

When the network is in a spike burst state, in the first half portion of this state, packages will arrive late and the packages in buffer are in danger of depletion because the most packages are blocked by the network. The size of buffer means the size of time delay of the data packets, and the buffer depletion means that the buffer can not be used for compensating the arrival time jitter of the data packages. Since the buffer adjustment is performed by using the circular queues, dummy packets are inserted to the head of the queue when it is necessary to increase the time delay so as to compensate the time delay fluctuation.

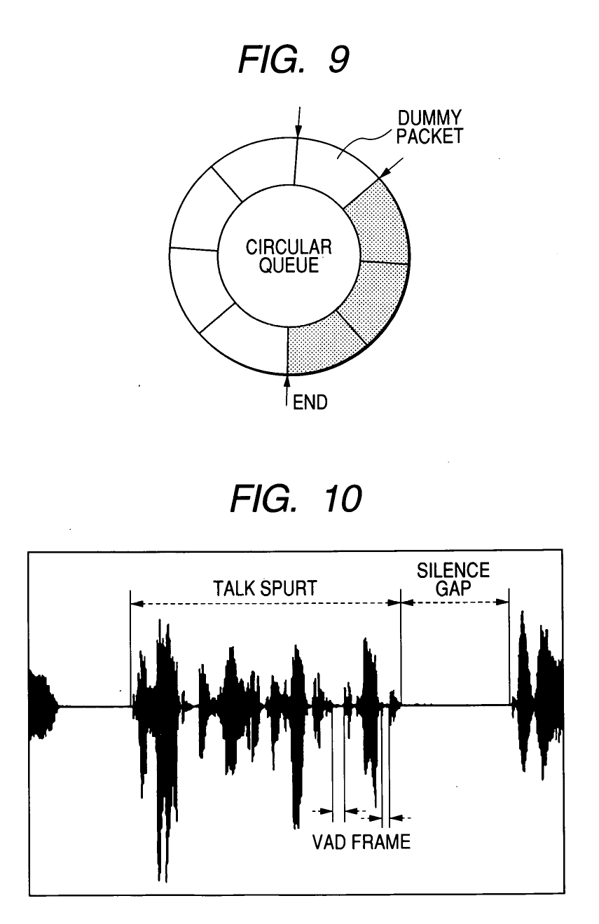

FIG. 9 shows a schematic diagram of circular queue and dummy packet inserting.

Here, dummy packet is a kind of data packet generated by the receiving end. Dummy packet is not transmitted through the network, but a data packet without voice energy inserted in the buffer by the receiving end to adjust the playing time of data packets when the network is in a spike state. Depending on different code formats, a dummy packet may contain the data totally without any voice energy, or a noise that is comfortable to human ears.

When inserting the dummy packets, they are inserted from the head of the queue. Two thresholds, i.e., L_{high} and L_{low}, are set for the size of buffer. The network is considered to be in a spike state when the size of the buffer is smaller than L_{low}, then the dummy packets are inserted to the head of the queue, one packet for each time, until the network is decided to have returned to a normal state only when the size of the buffer is larger than L_{high} after the blocked data packets arrive in succession. In this way, the spike state of the network will only bring about an interruption in two talk spurts, which has little effect on semantic understanding of the voice. However, in the traditional inserting method, the data packets are inserted only when the packets are lacking, this makes the originally continuous talk spurts intermittent, and thereby adding a big difficulty in understanding the contents of the voice.

In addition, it is known from the study of present inventor that the most preferred position to insert the dummy packets is the position of VAD packet, for the reasons of:

The human voice that hears continuous by human ears can be divided into talk spurt and silence gaps according to its characteristics in time zone if the time range is narrowed to millisecond. In the talk spurt, the energy of voice is not zero, and it is transmitted by corresponding data packets obtained by encoding the voice, however, in the silence gaps, the energy of voice is approaching to zero, and it will not be encoded to transmit by the sending end as shown in FIG. 10.

Nevertheless, even in one talk spurt, there may exist some time zones, in this short period of time, the energy of voice is quite low, and it will not affect the semantic understating even when the voice energy is zero. Since this period is very short, when a frame is completely filled with such time zones, the frame will still be encoded in order to avoid frequent hand over between silence gaps and talk spurts. The encoded frame is called VAD frame. These VAD frames are delivered, different from the data in silence gaps, so it will not affect the quality of voice to insert dummy packets at the position of VAD and throw away these data packets when necessary.

Besides, in the first half portion of the spike burst state, most data packets that have been blocked by the network will arrive at the same time, as a result, the number of data packets in the buffer will suddenly become too great to bear, and so will the time delay of the data packets.

The specific adjusting method can be divided into three steps:

1) When the buffer is not so big, do not receive VAD (Voice Activity Detector) data packets any more, and throw away the packets immediately once the RTP module detects that the received data packets are VAD packets;

2) When the step 1) has no obvious effect, remove VAD data packets in the buffer to narrow the buffer;

3) When the network is in a state of serious spike and both the above two steps have no obvious effect, for the application that requires smaller time delay, the playing time of each data packet has to be compacted by reducing sample values at the cost of part of voice quality. To be specific, reduce the voice sample values in each data packet at regular intervals to shorten the playing time of each data packet.

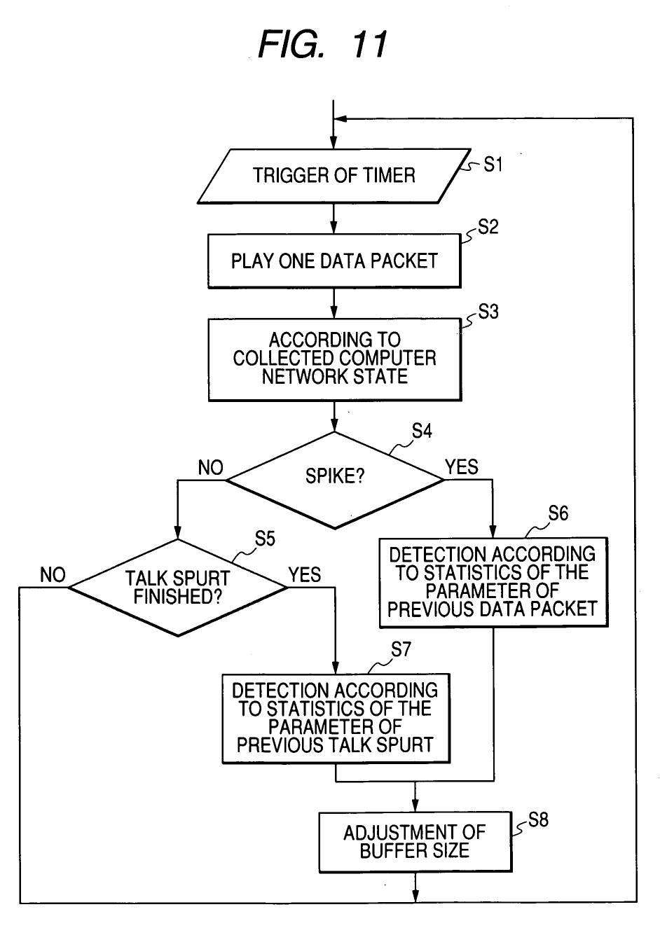

FIG. 11 shows a flow chart of the buffer control performed by a control module.

The present invention can keep the time delay of voice information of the communication terminal device stable, and avoid the loss of data packets.

1. A communication terminal device for use in IP telephone communication, comprising: a data packet unpacking unit for unpacking the received data packets containing the voice information; a receiving buffer for storing the unpacked data packets; a decoding unit for decoding the data packets saved in the receiving buffer; a playing unit for playing the voice information after the decoding unit decodes it; and a central control unit for controlling the data packet unpacking unit, the receiving buffer and the playing unit, wherein the central control unit comprises:
a network state decision section for deciding whether the network is in a spike state according to the received data packets; and
a buffer adjusting section, which predicts the sequent data packets in one group of data packet when the network is decided to be in a normal state to adjust the size of buffer, and predicts the sequent data packets in one data packet when the network is decided to be in a spike state to enlarge the buffer.

2. The communication terminal device according to claim 1, wherein the decision of network state means that the network is decided to be in a spike state when the time delay of data packets received by the data packet unpacking unit is larger than the preset first lower limit value of the delayed time of data packets.

3. The communication terminal device according to claim 1, wherein the decision of network state means that the network is decided to be in a spike state when the time interval of data packets received by the data packet unpacking unit is larger than the preset first lower limit value of the time delay of data packets.

4. The communication terminal device according to claim 1, wherein the decision of network state means that the network is decided to be in a normal state when the number of data packets stored in the receiving buffer is less than the preset first lower limit value, and the network is decided to be in a normal state when the number of data packets stored in the receiving buffer is larger than the second lower limit value which is higher than the first lower limit value.

5. The communication terminal device according to claim 1, wherein the buffer enlarging means that the central control unit inserts dummy packets to the receiving buffer from the head of the queue when the network state decision section decides that the network is in a spike state.

6. The communication terminal device according to claim 1, wherein the buffer enlarging means that the central control unit inserts dummy packets at the position of VAD packet in the buffer when the network state decision section decides that the network is in a spike state.

7. The communication terminal device according to claim 1, wherein the one group of data packet unit means a talk spurt.

8. The communication terminal device according to claim 1, wherein the sequent data packets are predicted with NLMS algorithm when the network is decided to be in a spike state.

9. The communication terminal device according to claim 1, wherein VAD data packet in the buffer is deleted when the number of data packets in the buffer is larger than the preset upper limit value.

10. A method of receiving IP telephone data, comprising the steps of:
deciding whether the network is in a spike state according to the received data packets; and
predicting the sequent data packets in one group of data packet when the network is decided to be in a normal state to adjust the size of the buffer, and predicting the sequent data packets in one data packet when the network is decided to be in a spike state to enlarge the buffer.

11. The receiving method according to claim 10, wherein the buffer enlarging includes the central control unit inserting dummy packets to the receiving buffer from the head of the queue when the network state decision section decides that the network is in a spike state.

12. A gateway connected between a router and a telephone for use in IP telephone communication, comprising: a data packet unpacking unit for unpacking the received data packets containing the voice information; a receiving buffer for storing the unpacked data packets; a decoding unit for decoding the data packets saved in the receiving buffer; a playing unit for playing the voice information after the decoding unit decodes it; and a central control unit for controlling the data packet unpacking unit, the receiving buffer and the playing unit, wherein the central control unit comprises:
a network state decision section for deciding whether the network is in a spike state according to the received data packets; and
a buffer adjusting section, which predicts the sequent data packets in one group of data packet when the network is decided to be in a normal state to adjust size of the buffer, and predicts the sequent data packets in one data packet when the network is decided to be in a spike state to enlarge the buffer.

13. A communication system for use in IP telephone communication, comprising: a sending device, a receiving device and a router which connects the sending device with the receiving device via internet, the receiving device comprises:
a data packet unpacking unit for unpacking the received packets containing the voice information; a receiving buffer for storing the unpacked data packets; a decoding unit for decoding the data packets saved in the receiving buffer; a playing unit for playing the voice information after the decoding unit decodes it; and a central control unit for controlling the data packet unpacking unit, the receiving buffer and the playing unit, wherein the central control unit comprises:
a network state decision section for deciding whether the network is in a spike state according to the received data packets; and
a buffer adjusting section, which predicts the sequent data packets in one group of data packet when the network is decided to be in a normal state to adjust the size of buffer, and predicts the sequent data packets in one data packet when the network is decided to be in a spike state to enlarge the buffer.
